(19) United States
(12) Patent Application Publication
(10) Pub. No.: US 2005/0048435 A1
(43) Pub. Date: Mar. 3, 2005

(54) Canal filling method and device for providing the filling product

(76) Inventor: Jean-Marie Badoz, Doubs (FR)

Correspondence Address: Gary M. Cohen, Esq.;Strafford Building Number Three, Suite 300, 125 Strafford Avenue, Wayne, PA, 19087-3318, US

(21) Appl. No.: 10/963,235

(22) Filed: Oct. 12, 2004

Related U.S. Application Data
(62) Division of application No. 10/049,350, filed on Jan. 30, 2002.

(30) Foreign Application Priority Data
Aug. 4, 1999 (FR) 99/10217

(51) Int. Cl. A61C 19/00; A61C 5/02; A61C 3/00

(52) U.S. Cl. 433/32; 433/81; 433/224

(57) ABSTRACT

A method for applying a filling material in paste form to a root-canal instrument, for introduction into the canal of a tooth using the instrument, uses a filling material which is contained in a cartridge in a dose which roughly corresponds to the amount needed for treating and filling a single canal. The instrument can then be plunged, rotating or stationary, into one of the cartridges to pick up just the amount of filling material needed for the procedure. A device for making the filling material available for use operates to receive the cartridge, to heat the dose of filling material and to maintain the filling material at its desired temperature, and a cartridge is provided for use with the device and to perform the method.

### RELATED CASE

This is a divisional of U.S. patent application Ser. No. 10/049,350, filed Jan. 30, 2002.

### BACKGROUND OF THE INVENTION

The present invention relates to the field of obturation methods for filling the root canals of teeth, and more specifically, to the phase of such methods where the canal in the tooth is filled using a filling material such as Gutta percha or some other type of material. The present invention relates, in particular, to the use of a filling material in the form of a paste which is introduced into the root canal using a root-canal instrument known as a “condenser”, which comprises a screw and which is arranged on a handpiece. The present invention also relates to a device for making filling material available and to a container for containing the filling material.

Procedures for filling root canals are already known in the art. For example, methods are known which make use of an instrument, the body of which is made of plastic and onto which Gutta percha is added. To perform the filling procedure, the assembly is introduced, after heating, into the canal. A major disadvantage with this method is that the plastic body remains in the canal and causes considerable inconvenience if the filling work being performed subsequently needs to be repeated.

Also known is a method which arranges the filling material on an instrument known as a “condenser”, which takes the form of a root-canal instrument with a screw, for example, a left-hand screw, arranged on a handpiece so that the filling material can be deposited or “condensed” into the canal by rotating the instrument in the opposite direction to the hand of the screw. To coat the instrument with filling material, such as Gutta percha for example, the Gutta percha is arranged in a syringe placed in a heater and the plunger of the syringe is actuated when the Gutta percha is ready so as to deposit the Gutta percha onto the root-canal instrument positioned adjacent to the outlet of the syringe.

Methods which make use of such condensers have two disadvantages. On the one hand, such methods do not allow precise control over the amount of Gutta percha applied to the root-canal instrument. On the other hand, because the amount of Gutta percha contained in the syringe is great, the dental practitioner is strongly tempted to treat several root canals belonging to different patients using the same syringe. In this latter case, there is then a risk that the practitioner will contaminate the second patient (or patients) with bacteria from the first patient (or patients).

### SUMMARY OF THE INVENTION

The present invention overcomes these drawbacks by presenting the filling material in the form of at least one dose arranged in a cartridge type container. Each dose is an individual dose, corresponding roughly to the amount needed to treat and fill just one canal. The root-canal instrument is plunged, rotating or stationary, into one of the cartridges containing a dose of filling material, providing just the amount of filling material needed to carry out the operation of filling the root canal so that the proper amount of filling material is picked up on the walls of the root-canal instrument. This makes it possible to fill the root canal of the tooth using just the amount of filling material needed, and under optimum hygiene conditions.

The device for making the filling material available in accordance with the present invention is notable in that it allows at least one cartridge containing filling material in a dose roughly corresponding to the amount needed to treat and fill one single canal to be brought up to and maintained at the desired temperature.

The cartridge type container for the filling material which allows the filling of root canals in accordance with the present invention is notable in that it contains at least one dose of filling material roughly corresponding to the amount needed to treat and fill one single canal. The cartridge type container can therefore be sold independently, or in large quantities, ready for use and disposable after use.

The present invention will be better understood with reference to the description of two embodiments of the invention which is given below by way of example, together with the following drawings.

### BRIEF DESCRIPTION OF THE DRAWINGS

FIG. 1 is an isometric view of a first alternative embodiment device of the present invention.

FIG. 2 illustrates the phase of coating a root-canal instrument.

FIG. 3 is an enlarged cross-sectional view of a cartridge produced in accordance with the present invention which can be used with the device shown in FIG. 1.

FIG. 4 is an isometric view of a second alternative embodiment device of the present invention.

FIG. 5 is an enlarged, longitudinal cross-sectional view of the device shown in FIG. 4.

### DETAILED DESCRIPTION OF THE INVENTION

The method of the present invention is a method for filling root canals using a filling material (1) such as Gutta percha or some other type of filling material. The filling material, in the form of a paste, is introduced into the root canal using a root-canal instrument (2) known as a “condenser”, which comprises a screw and which is arranged on a handpiece (3).

In accordance with the present invention, the filling material (1) is in the form of a dose (4), each of which is arranged in a cartridge (5). Each dose (4) roughly corresponds to the amount of filling material needed to treat and fill one single canal.

To deposit the filling material (1) on the root-canal instrument (2), the root-canal instrument (2) is plunged, rotating or stationary, into one of the cartridges (5) containing a dose (4) of the filling material (1) so that just the amount of filling material needed for the filling operation is picked up on the walls of the root-canal instrument (2), as is illustrated in FIG. 2.

To fill the root canal, all that is then required is for the root-canal instrument (2) to be correctly positioned in the root canal and made to rotate in the opposite direction to the hand of the screw so as to fill the root canal with filling material (1). It should be noted that, by virtue of the method of the present invention, it is not necessary to reverse the direction of rotation of the screw of the root-canal instrument in order to load the screw with filling material.

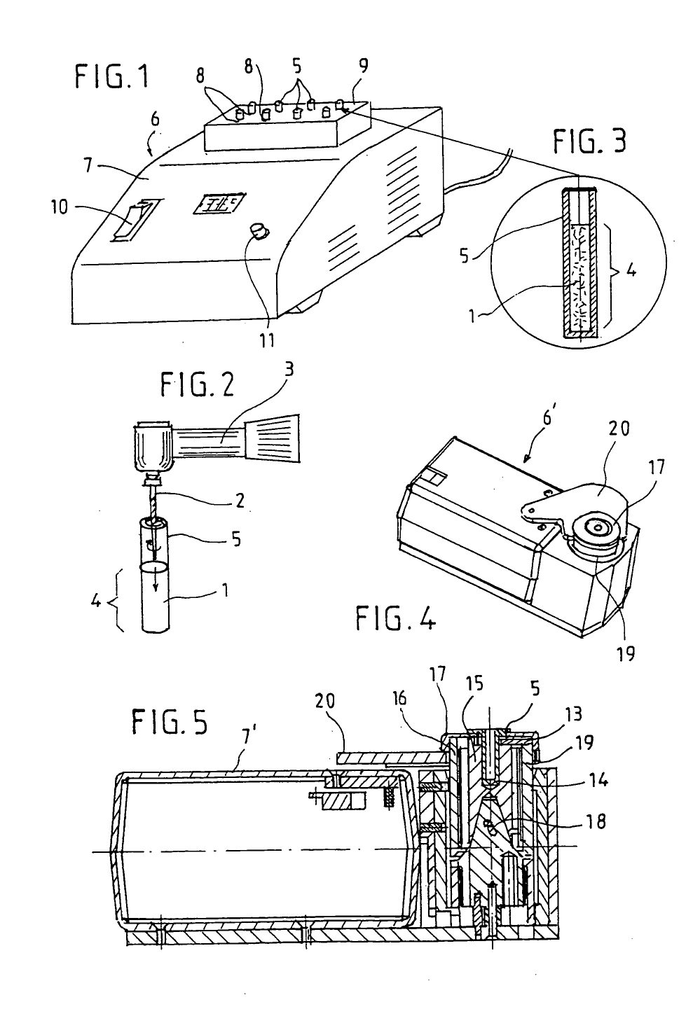

FIG. 1 shows a device (6) for making available filling material (1) of the Gutta percha type (or some other type) in the form of a paste, for introduction into the canal of a tooth using a root-canal instrument. The illustrated instrument (2), known as a “condenser”, comprises a screw and is arranged on a handpiece (3). The device (6) operates to allow at least one cartridge (5) containing filling material (1) in a dose (4) roughly corresponding to the amount needed to treat and fill one single canal to be brought up to and maintained at the desired temperature.

The device (6) can, for example, take the form of a unit (7) comprising a number of recesses (8), each of which can receive a cartridge (5). One or more of the recesses (8) are formed in a heat-conducting heating body (9) which can be heated, for example, using a resistive electric element, to raise at least one cartridge (5) to the desired temperature and to maintain the cartridge (5) at that temperature. The device (6) may further comprise a switch (10) and an operating indicator (11).

The cartridge (5) illustrated in FIG. 3 contains an individual dose (4) of filling material (1) roughly corresponding to the amount needed to treat and fill one single canal. The cartridge (5) is, for example, formed as a hollow cylinder having a bottom and is made of plastic. The cartridge (5) is also preferably equipped with a sealed closure, such as a stopper or a thermally bonded seal for example, that can be opened just before the filling material is to be picked up. The cartridges (5) of filling material (1) can be distributed ready for use, and are disposable (i.e., ready to be heated in the device (6) and able to be disposed of after the contained filling material has been used).

FIGS. 4 and 5 show a device (6′) which essentially comprises a unit (7′) equipped with the usual controls and supplies for an electrical device (e.g., switches, on-off indicator light, timer, etc.). In this alternative form, the cartridge (5′) is placed in a pot (13) comprising a central housing (14) for accommodating the cartridge, a thermal mass (15), and thermally insulated external surfaces (16, 17), with the surface (16) surrounding the body of the pot (13) and with the surface (17) extending over the top surface of the pot (13).

The thermal mass (15) is accessible toward the bottom of the pot (13) and has a female cavity which accommodates a heating rod (18). The insulated surface (17) forms a lid on the pot (13), and has a circular shoulder (19) which collaborates with a trigger (20) articulated to the body (7′) to allow the pot (13), possibly with a cartridge (5), to be locked in and released from the device (6′). The trigger (20) operates to hold the pot (13) in its housing and, when the pot (13) is removed, to completely close off the housing to prevent dirt from entering the housing, which could then disturb the contact between the heating body and the thermal mass of the pot (13). Furthermore, the trigger (20) prevents the risk of contact between fingers and the high-temperature heating body. The thickness of the trigger (20) is such that it can be moved aside simply, under the pressure of the pot, held by hand by the user.

The thermal inertia of the mass (15) allows the user to work while leaving the device as it is, and handling only the pot and the cartridge it contains. The pot and its thermal mass may be sterilized, while the doses (the cartridges) can be sold sterile. As a consequence, the device (6′) is more flexible to use than the alternative device (6) shown in FIGS. 1 to 3.

1. An apparatus for providing a filling material, in paste form, for introduction into a canal of a tooth using a root-canal instrument including a screw which is arranged on a handpiece, comprising:
a removable pot including a heat-conducting element having at least one recess for receiving a cartridge containing the filling material, wherein the cartridge contains a dose of the filling material which approximately corresponds to an amount of the filling material which is needed to treat and fill one single canal; and
a heater coupled with the heat-conducting element and the recess, wherein the heater operates to bring the dose of the filling material up to a desired temperature and to maintain the dose of the filling material at the desired temperature.

2. The apparatus of claim 1 wherein the pot comprises:
a central housing for accommodating the cartridge,
a body formed of a thermal mass and including the central housing; and
thermally insulated external surfaces including a first insulated surface surrounding the body of the pot and a second insulated surface extending over top portions of the pot.

3. The apparatus of claim 2 wherein the thermal mass has an accessible bottom portion, and wherein the accessible bottom portion of the thermal mass has a female cavity for engaging the heater.

4. The apparatus of claim 3 wherein the heater is a heating rod for engaging the female cavity of the thermal mass.

5. The apparatus of claim 2 wherein the second insulated surface forms a lid on the pot, and wherein the second insulated surface has a circular shoulder which collaborates with a trigger for releasably engaging the pot.

6. The apparatus of claim 5 which further includes a casing for receiving the pot, and wherein the trigger is coupled with the apparatus for articulation relative to the casing.

7. The apparatus of claim 6 wherein the trigger is coupled with the apparatus for articulation between a first position which completely closes off the casing when the pot is removed from the casing and a second position which is retracted from the first position to permit the pot to be inserted into and withdrawn from the casing.

8. The apparatus of claim 7 wherein the pot is releasably locked in the casing when the trigger is in the second position.

9. The apparatus of claim 8 wherein the cartridge is received in the central housing of the pot.

10. The apparatus of claim 6 wherein the trigger has a thickness allowing the trigger to be moved aside, by hand, against the pressure of the pot.

11. The apparatus of claim 1 wherein the root-canal instrument is a condenser.

12. The apparatus of claim 1 wherein the filling material is Gutta percha.

13. The apparatus of claim 1 wherein the cartridge is a hollow vessel fitted with a sealed closure for establishing sterility of the vessel.

14. The apparatus of claim 13 wherein the hollow vessel is a cylinder having an integral bottom at one end and the sealed closure at an opposite end.

15. The apparatus of claim 13 wherein the vessel is formed of a plastic material, for establishing the sterility of the vessel.
